(19) United States
(12) Patent Application Publication
(10) Pub. No.: US 2018/0114021 A1
(43) Pub. Date: Apr. 26, 2018

(54) OPTIMIZING DATA DETECTION IN COMMUNICATIONS

(71) Applicant: NOKIA SOLUTIONS AND NETWORKS OY, Espoo (FI)

(72) Inventors: Ian Justin OLIVER, Söderkulla (FI); Silke HOLTMANNS, Klaukkala (FI)

(21) Appl. No.: 15/561,724

(22) PCT Filed: Mar. 26, 2015
(86) PCT No.: PCT/EP2015/056610

§ 371 Date: Sep. 26, 2017

(51) Int. Cl. G06F 21/56; G06F 21/62; H04L 29/06

(52) U.S. Cl. CPC G06F 21/566; G06F 21/564; G06F 21/6254; H04L 2463/141; H04L 63/1441; H04L 69/22; H04L 63/1408

(57) ABSTRACT

A method comprises acquiring (201), in a network node (NE1), data transmitted between network nodes of a communication system. The network node (NE1) processes (202) the acquired data in order to optimize data scanning in the communication system, and provides (203) an output indicating selected data fields for which data scanning is to be performed. The processing (202) of the acquired data comprises classifying data fields of a data set based on selected data scanning characteristics of the data fields, calculating, based on the classifying, the sensitivity of the data fields, forming a first partial order of the data fields based on their sensitivity, forming a second partial order of the data fields based on their usage, and sorting, based on the first and second partial order, the data fields into data scanning categories.

### TECHNICAL FIELD

The invention relates to communications.

### BACKGROUND

Malicious software (malware) refers to software used to disrupt or modify computer or network operations, collect sensitive information or gain access to a private computer or network system. Malware has a malicious intent, acting against the requirements of a user or network operator. Malware may be intended to steal information, gain free services, harm an operator's business or spy on the user for an extended period without the user's knowledge, or it may be designed to cause harm. The term malware may be used to refer to a variety of forms of hostile or intrusive software, including mobile computer viruses, worms, Trojan horses, ransomware, spyware, adware, scareware and/or other malicious programs. It may comprise executable code, or an ability to download such, scripts, active content and/or other software. Malware may be disguised as or embedded in non-malicious files.

### BRIEF DESCRIPTION

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following, the invention will be described in greater detail by means of preferred embodiments with reference to the accompanying drawings, in which

FIG. 1 illustrates a wireless communication system to which embodiments of the invention may be applied;

FIG. 2 is a signalling diagram of a procedure for optimizing data scanning according to an embodiment of the invention;

FIG. 3 illustrates a process for optimizing data scanning according to an embodiment of the invention;

FIG. 4 illustrates running the malware signature check;

FIG. 5 illustrates optimizing data scanning according to an embodiment;

FIG. 6 illustrates the labelling of data usage according to an embodiment;

FIG. 7 illustrates the labelling of data information types according to an embodiment;

FIG. 8 illustrates the labelling of sensitive data according to an embodiment;

FIG. 9 illustrates relations between sensitive data, required data and extracted data;

FIG. 11 illustrates classifying and partitioning of data according to an embodiment;

FIG. 12 illustrates data field selection and alert processing according to an embodiment.

FIG. 13 illustrates the operation of a classical malware detector;

FIG. 14 illustrates data scanning where sensitive data fields are merely suppressed;

FIG. 15 illustrates data scanning according to an exemplary embodiment;

FIG. 16 illustrates utilizing a separate storage for incident recovery and legal investigation;

FIG. 17 illustrates utilizing an encrypted storage with access control;

FIG. 18 illustrates a process for optimizing data scanning according to an embodiment of the invention;

FIG. 19 illustrates a blocks diagram of an apparatus according to an embodiment of the invention.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

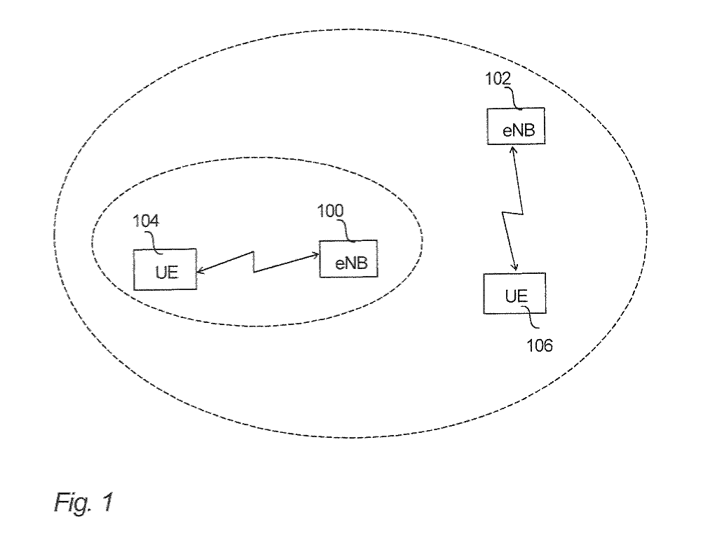

FIG. 1 illustrates a wireless communication scenario to which embodiments of the invention may be applied. Referring to FIG. 1, a cellular communication system may comprise a radio access network comprising base stations disposed to provide radio coverage in a determined geographical area. The base stations may comprise macro cell base stations (eNB) 102, home eNode-Bs (HeNB), home node-Bs (HNB) or base stations (BS) arranged to provide terminal devices (UE) 106 with the radio coverage over a relatively large area spanning even over several square miles, for example. In densely populated hotspots where improved capacity is required, small area cell base stations (eNB) 100 may be deployed to provide terminal devices (UE) 104 with high data rate services. Such small area cell base stations may be called micro cell base stations, pico cell base stations, or femto cell base stations. The small area cell base stations typically have significantly smaller coverage area than the macro base stations 102. The cellular communication system may operate according to specifications of the 3^{rd} generation partnership project (3GPP) long-term evolution (LTE) advanced or its evolution version (such as 5G).

Mass surveillance of core network and roaming interfaces is seen as a tool to detect terrorist activities or to counteract attacks on critical communication infrastructure. In mass surveillance systems everybody is under suspicion to some degree. Thus the principle of innocent till proven guilty does not seem to apply to modern surveillance technology usage. On the other hand, criminals may easily benefit from communication networks that are not protected. Too much data collection means that the privacy of the user is compromised and network nodes may be hacked (or become a national security agency (NSA) target) because of the data stored. If too little data is collected, then data scanning for malware detection does not work, and the network is vulnerable. The larger the amount of data, the slower is the data checking, and thus potential countermeasures are less efficient (due to a delay). The consumer perception of a company/device/system collecting large amounts of data is very negative with regards to privacy.

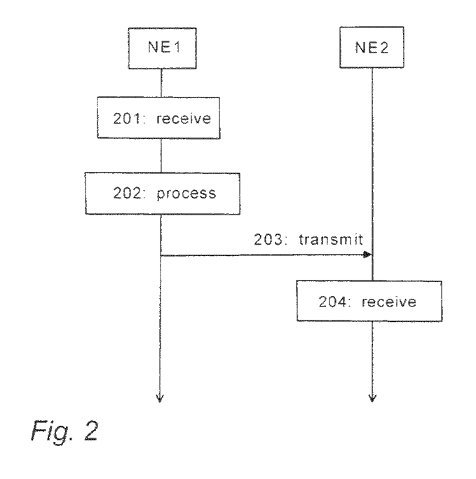

Let us now describe an embodiment of the invention for data scanning with reference to FIG. 2. FIG. 2 illustrates a signalling diagram illustrating a method for signalling data scanning parameters between network nodes of a communication system, e.g. a first network node NE1 and a second network node NE2. The network node NE1, NE2 may be a server computer, host computer, terminal device, base station, access node or any other network element that do not reside on the edge of the network, for example, a part of the core network (e.g. VLR, HLR). For example, the server computer or the host computer may generate a virtual network through which the host computer communicates with the terminal device. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer. External network virtualization is targeted to optimized network sharing. Another category is internal virtual networking which provides network-like functionality to the software containers on a single system. Virtual networking may also be used for testing the terminal device.

Referring to FIG. 2, the first network node NE1 is configured to collect (block 201) data received from other network nodes of the communication system. The first network node NE1 is configured to process (block 202) the collected data in order to optimize data scanning in the communication system. Based on the processing, the first network node NE1 is able to transmit (step 203) an output message to the second network node NE2. The second network node NE2 is configured to receive (block 204) the output message and, based on that, perform data scanning. Data scanning may include, for example, malware detection, spam detection, terrorist identification and/or network statistics detection.

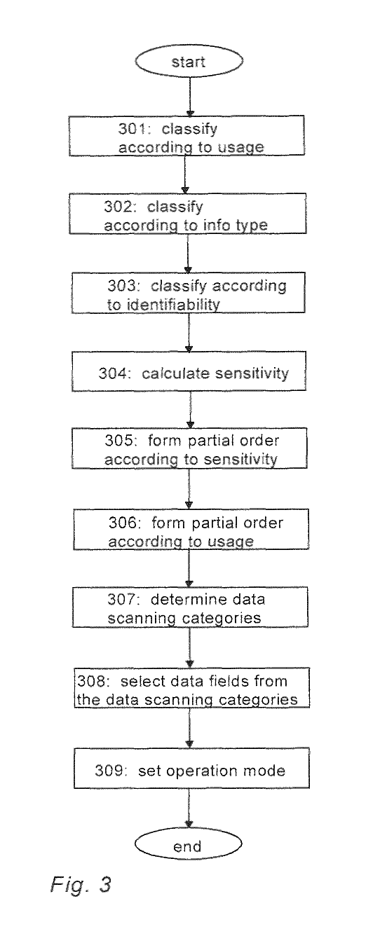

Let us now describe some embodiments of block 202 with reference to FIG. 3. FIG. 3 illustrates embodiments for labelling, sorting and selecting data fields for data scanning. Referring to FIG. 3, the first network node NE1 is configured to classify 301 (i.e. label) data fields of a data set according to usage (for what purpose are the data fields used). In item 302, the first network node NE1 is configured to classify the data fields of the data set according to information type (which type of data is included in the data fields). In item 303, the first network node NE1 is configured to classify the data fields of the data set according to identifiability of the data set (does the data include sensitive data according to privacy laws). In item 304, the first network node NE1 is configured to calculate the sensitivity of the data fields based on the classifying performed in items 301, 302, 303. In item 305, the first network node NE1 is configured to form a first partial order of the data fields and data subsets according to the calculated sensitivity. In item 306, the first network node NE1 is configured to form a second partial order of the data fields based on the usage of the data fields alone. In item 307, the first network node NE1 is configured to sort the data fields into various data scanning categories based on the first and second partial order. In item 308, the first network node NE1 is configured to select a minimum set of data fields from each of the data scanning categories based on predetermined operation criteria. In item 309, the first network node NE1 is configured to set the operation mode of data scanning to be the minimum set of data fields that satisfies a lowest risk level (i.e. it is defined that data scanning is to be performed on the selected minimum set of data fields required to perform an assigned protection task).

An embodiment enables selecting data fields to be processed, stored and released for further processing by a data scanning entity, whilst respecting privacy laws and avoiding abusive collection of personal data. If too much data is collected in some network nodes, this may pose a risk to become a potential target of attackers. Thus, mechanisms are provided for partitioning these with respect to the mode of operation.

In an embodiment, the actual data scanning (block 204) is carried out in the same network node as the optimizing (block 202) of the data scanning. In that case, the transmission of the output message (step 203) may not be needed.

An embodiment provides a mechanism where the processing and collecting of data may be temporarily increased to support greater fidelity of data scanning, such as malware detection, spam detection, terrorist identification, network statistics detection and/or other detection, in a justifiable and privacy law compliant manner.

An embodiment provides a method for reduction of the amount of fields and applying privacy tools to a set of collected data (obtained e.g. from data scanning entity, radio measurement system). A classification mechanism for data usage, privacy sensitivity and risk is included. Thus user privacy is obtained, while still enabling user protection against criminals or unauthorized intruders.

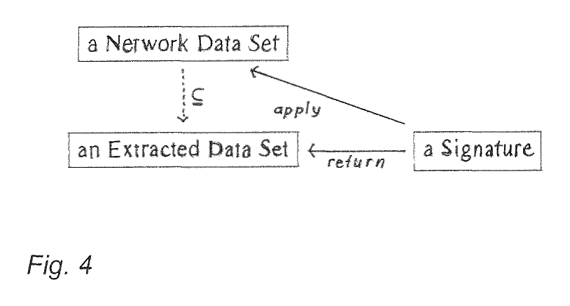

The relevant part of data is extracted from a large set of network data, such that the data scanning is still possible. Malware detection may include the signature of the malware (its fingerprint), and the signature of the malware is applied on the extracted data set. FIG. 4 illustrates running the malware signature check over extracted data set instead of full network data set.

An embodiment comprises a classification step for identifying privacy relevance (labelling). The fields of a data set are classified according to usage (an input from product and service usage). The fields of a data set are classified according to information type (what data is included). The fields of the data set are classified according to the overall identifiability of that particular data set (privacy law).

An embodiment comprises a procedure for defining a privacy relevance output. The sensitivity of the fields is calculated according to a metric calculated over selected properties. A partial order of the data fields is formed according to the sensitivity, and partial order of data subsets is formed according to the sensitivity. The fields of the data set are classified according to usage, alone, and a partial order of the data fields is formed according to usage. The cross product (combination) of the two partial orders (i.e. the partial order of the data fields and the partial order of the data subsets) is mapped according to the risk, the data fields are partitioned into various data scanning categories, and the operation of the data scanning entity is rated into the various data scanning categories.

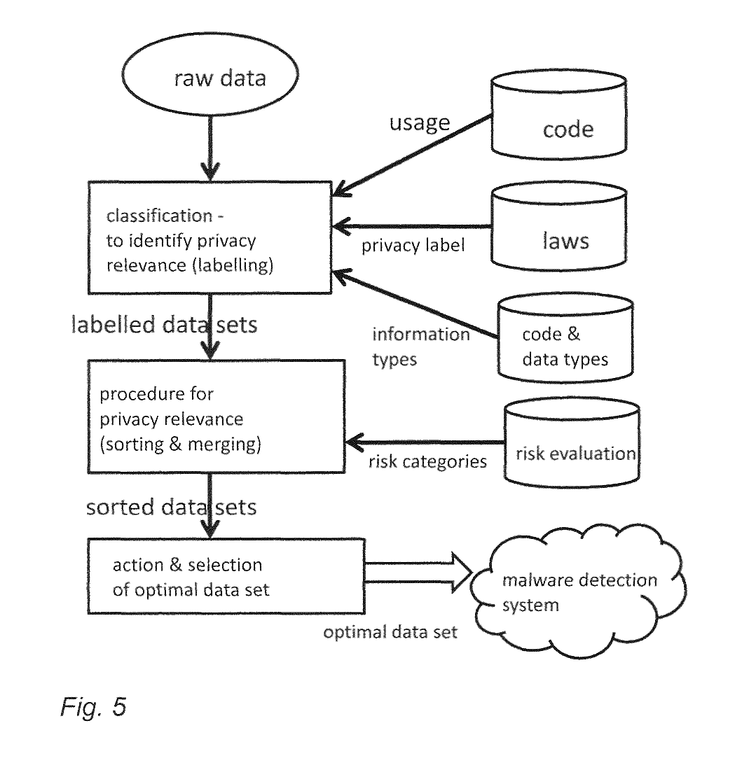

An embodiment comprises acting according to the privacy relevance procedure output. A minimum set of fields is selected from each of the data scanning categories corresponding to the operation of the data scanning entity. The data scanning entity default mode for the data collection is set to be the minimum set of fields that satisfies a lowest risk level corresponding to the required usage of data for, ostensibly, data scanning/malware detection purposes. FIG. 5 illustrates optimizing data scanning according to an exemplary embodiment.

Sorting (i.e. classification) and labelling of the data fields is carried out based on reducing the information content in terms of sensitivity and identifiability (i.e. privacy wise the data becomes less sensitive) of the data set over the required usages of that information as defined by the malware signature. This also applies to other type of user data collection, e.g. collecting of radio measurements, SON (self organizing networks), MDT (mobile drive tests). Thus performing of data scanning on sensitive and/or private data may at least partly be prevented.

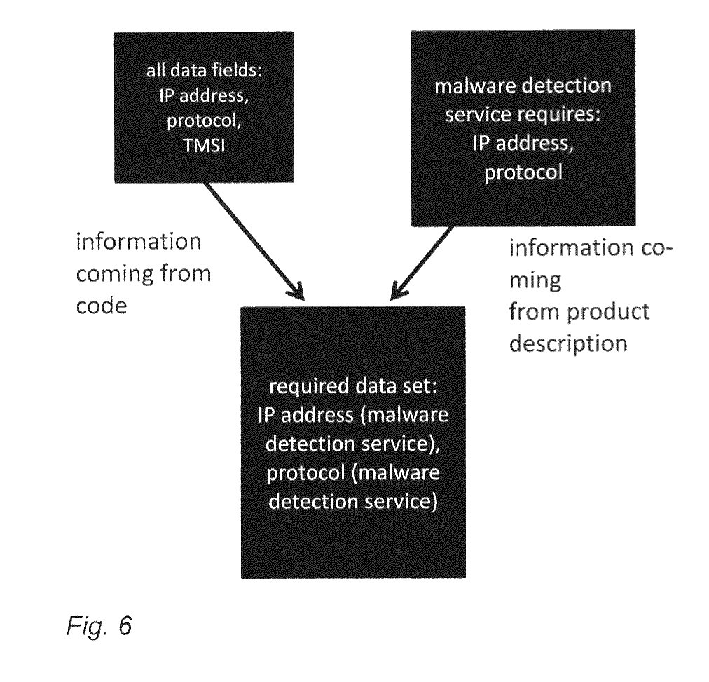

Classifying according to the usage may be based on code investigation. This may comprise attaching, during programming, on each piece of data, information on what the piece of data is actually used for. Based on the code, it may thus be seen which data is used and where (for what purpose) and what is the required data to get a service running. This may require input and knowledge about the services that are going to be performed. FIG. 6 illustrates the labelling of the data usage according to an embodiment.

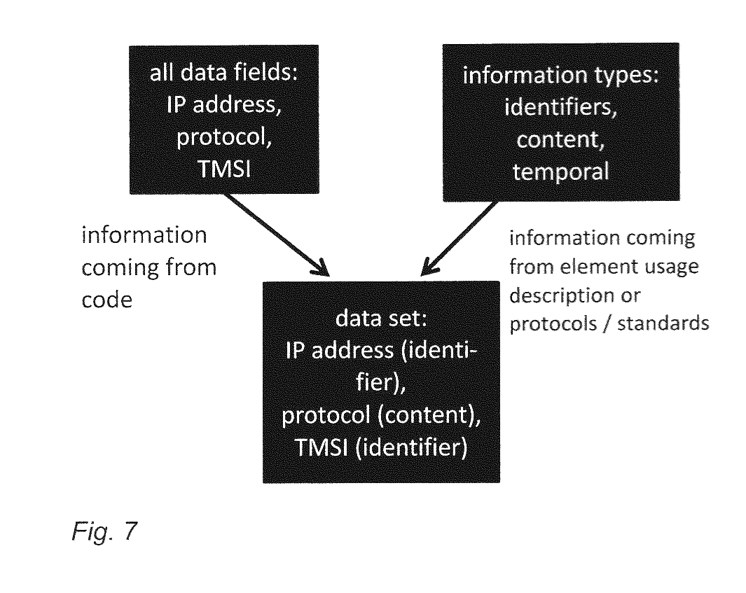

Classifying according to the information type may be based on investigating the field types for their variables, for example, what kind of data they have, are they names/IP (internet protocol) addresses etc., what certain strings etc. represent. Herein, each data field is assigned an information type. FIG. 7 illustrates the labelling of data information types according to an embodiment.

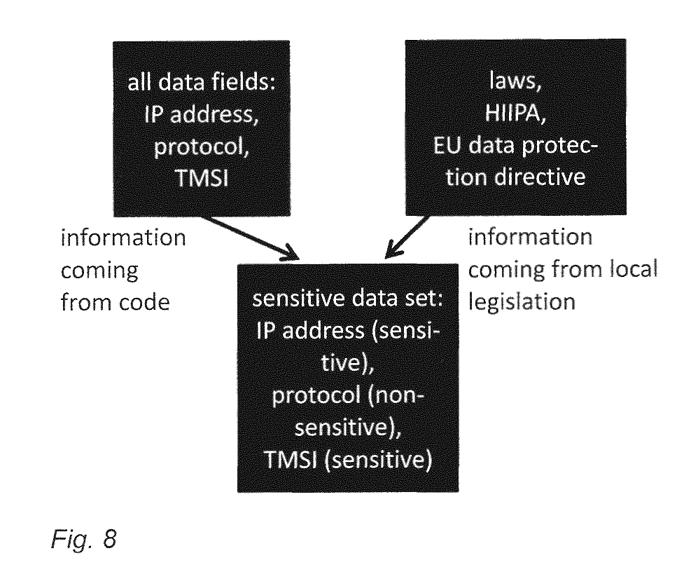

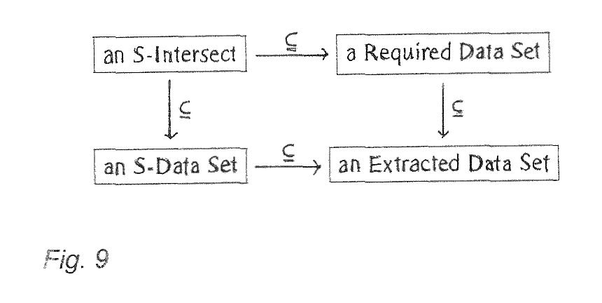

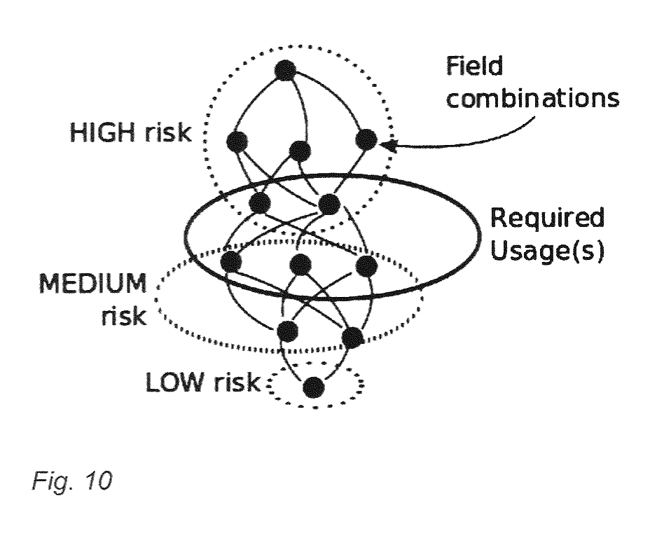

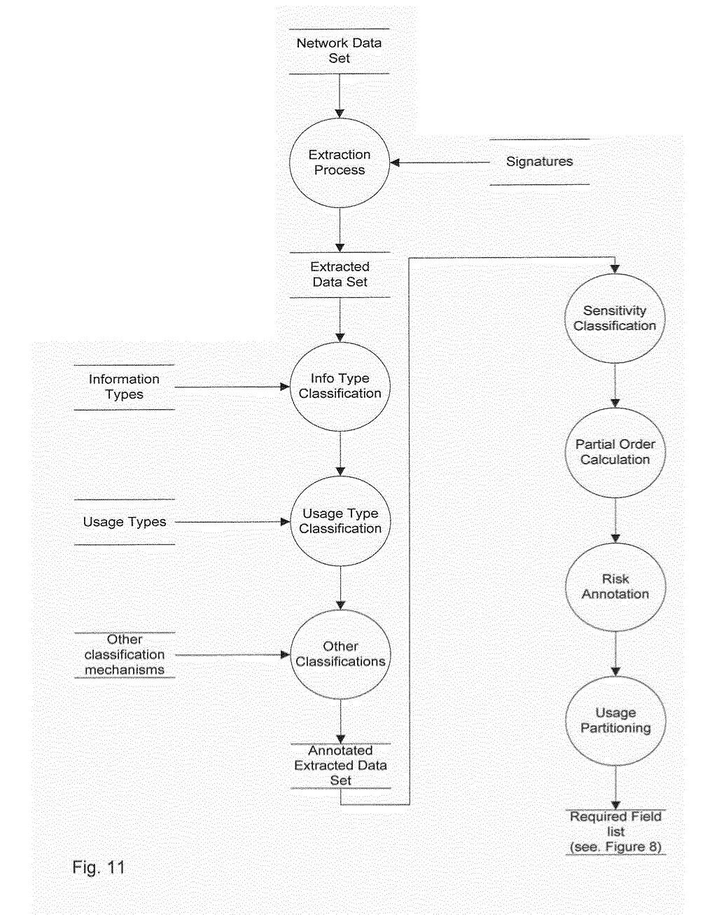

Classifying according to the sensitivity may be based on local legislation and/or on evaluating which data actually is sensitive and which is not. For example, in USA, phone location information is not privacy sensitive, while in European union (EU) it is. Herein, a sensitivity level is assigned to each data field. The data that is labelled sensitive may be referred to as “S-data” (sensitive=high, non-sensitive=low; see FIG. 8)). FIG. 7 illustrates the sensitive data labelling according to an embodiment. Herein S-data refers to the sensitive data, and S-intersect refers to data that is needed for data scanning AND that is privacy sensitive (e.g. IP address). The amount of S-Data (sensitive data) is minimised such that a minimum amount of privacy sensitive data is handled. The amount of S-Intersect is minimised such that the malware signature is optimised not to require privacy sensitive data (the amount of data that may be collected for data scanning is maximised without having a clash with privacy law). The amount of required data is maximised such that the malware signature is optimised for data scanning. FIG. 4 and FIG. 9 illustrate data relations between sensitive data, required data and extracted data (S-data, required data and S-intersect). S-intersect includes data that is needed for the data scanning and that is privacy sensitive. S-intersect is a subset (part of) the sensitive data. S-intersect is a subset (part of) the required data. The extracted data basically is a large data set that there is in the beginning before the data scanning process starts.

Once the extracted data is created, the information contained therein is classifled according to its information type and usage, independently of the machine type. When the data classified and labelled according to the usage, information type and sensitivity is combined, an exemplary output may be classified and labelled as illustrated below in Table 1.

TABLE 1
Exemplary combined labelling

| Data Field | Info Type | Usage | Sensitivity | Action to be taken |
|---|---|---|---|---|
| Event Identity | Identifier | Handling | LOW | No action |
| Timestamp | Temporal | Detection | MEDIUM | Inspect for aggregation risk |
| Event Type | Content | Handling | LOW | No action |
| Access Node | Identifier (machine address) | Not Needed | MEDIUM | Remove field |
| Destination IP Address: | Identifier (machine address) | Detection | HIGH | Protection action needed |
| Port Number | Content | Detection | LOW | No action |
| Protocol | Content | Detection | LOW | No action |
| Method | Content | Detection | LOW | No action |
| Risk Rating | Content | Mitigation | LOW | No action |
| Access device type | Identifier (physical object) | Detection | MEDIUM | Inspect for aggregation risk |
| Device Identity | Identifier (machine address) | Mitigation | HIGH | Protection action needed |
| IMSI | Identifier (machine address) | Mitigation | HIGH | Protection action needed |
| Device IP | Identifier (machine address) | Detection | HIGH | Protection action needed |

A privacy relevance procedure comprises deciding, based on the obtained usage, sensitivity and information type for each element, how to minimize the amount of data so that it still is possible to run the service (e.g. malware) over it successfully.

The sensitivity is calculated from a combination of the usage and information type along with the combined identifiability of the data calculated from the entire data set.

Regarding partial order creation for the sensitivity, the combinations of data such as {destination IP address, protocol, IMSI} may form one set. {Destination IP address, protocol} may form another set. The set {destination IP address, protocol, IMSI} is more sensitive (according to the calculated sensitivity value), and the set {destination IP address, protocol} is less sensitive. Thus these groups of data may be sorted into an order by their sensitivity.

Alternatively or in addition to creating the partial order over the sensitivity, other fields, annotations and calculated values may also be incorporated into the ordering metric. {Destination IP address, protocol, IMSI}>{destination IP address, protocol} may form the partial order (or lattice) of each field, for example:

$$\begin{matrix}\{ ( De vIP , IMSI , DevID , DestIP , … ) \} ≻ \\ \{ ( DevIP , IMSI , DevID ) , … ) \} ≻ \\ \{ ( DevIP , IMSI ) , … \} ≻ \\ ⋮ \\ \{ ( EventID ) , ( EventType ) , … \}\end{matrix}$$

Regarding partial order creation for the usage, the partial order for the usage is calculated. For a basic service, only a few data fields are required e.g. {MSISDN, TMSI}, but for a high value service more data may be required e.g. {MSISDN, TMSI, PIN}. {MSISDN, TMSI, PIN}>{MSISDN, TMSI} gives a partial order for the usage (i.e. similar to that of the partial order for the sensitivity).

The two partial orders (usage, sensitivity), do not yet indicate which data fields really are under high risk and need to be protected thoroughly, and which data fields are less important. The data set on top (the first data set) is more sensitive than the other sets. A mapping to a data scanning category is made over these by combining the partial orders and the risk, wherein an exemplary intersection of the field lattice, the usages and data scanning categories are illustrated in FIG. 10. FIG. 10 illustrates risk versus data fields, where each spherical point represents one of the subsets such as {MSISDN, TMSI, PIN}. The more sensitive the subset is, the higher it is in FIG. 10. The dotted line circles indicate the risk rating (obtained from an IT risk management system). For example, if MSISDN alone is exposed, that is not too big a risk, as MSISDN alone is public information anyway. In other words, the spherical point within the low risk circle may represent MSISDN, for example. The solid line circle indicates that the data (the spherical points) within it is absolutely required for data scanning, e.g. for malware detection.

Thus it is possible to determine the required data combinations, whether privacy is ok and what information there is. To take action, the determined data is collected and sent to the data scanning entity. Taking the set of fields in the intersection of the required usages and, for example, a medium data scanning category in this section, provides the set of data fields with a maximum privacy with respect to some risk criteria (these usages may then be mapped into a particular mode of operation of the data scanning entity). As the level of risk to be tolerated for the situation at hand increases, the number of fields or the set of fields is taken from a higher data scanning category.

Alternatively, the reduction or addition of noise addition (differential privacy, I-diversity, t-closeness, k-anonymity) may be used as mechanisms for controlling the sensitivity and risk characteristics of the data fields.

FIG. 11 illustrates a method for classifying and partitioning data according to an embodiment, where inputs/annotations required for the classifying and partitioning are shown.

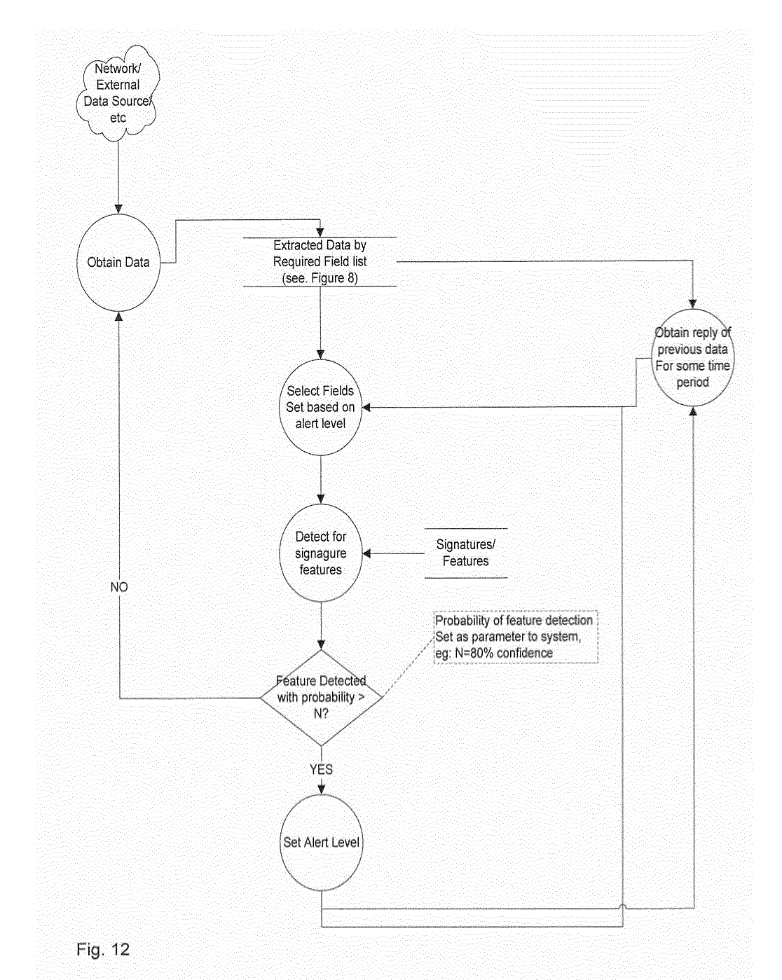

FIG. 12 illustrates data field selection and alert processing according to an embodiment.

Regarding the fidelity of data for the data scanning, typical data scanning assumes access to a wide range of fields and content. This is in contradiction with various privacy laws, and runs a number of risks such as accusations of surveillance and the potential for the over-collection of data. Data scanning also is a rather imprecise process with a number of false positive and negative results even in the above situation. Reducing the fidelity of the data by removing fields, hashing certain content, introducing noise and diversity still allows the data to be used statistically, but individual records are no longer attributable to unique persons. This reduced fidelity data is thus more privacy compliant and may thus be sufficient to satisfy privacy laws. The data scanning and the risk to network and consumer with the result of the increase in fidelity may then be better justified under these circumstances.

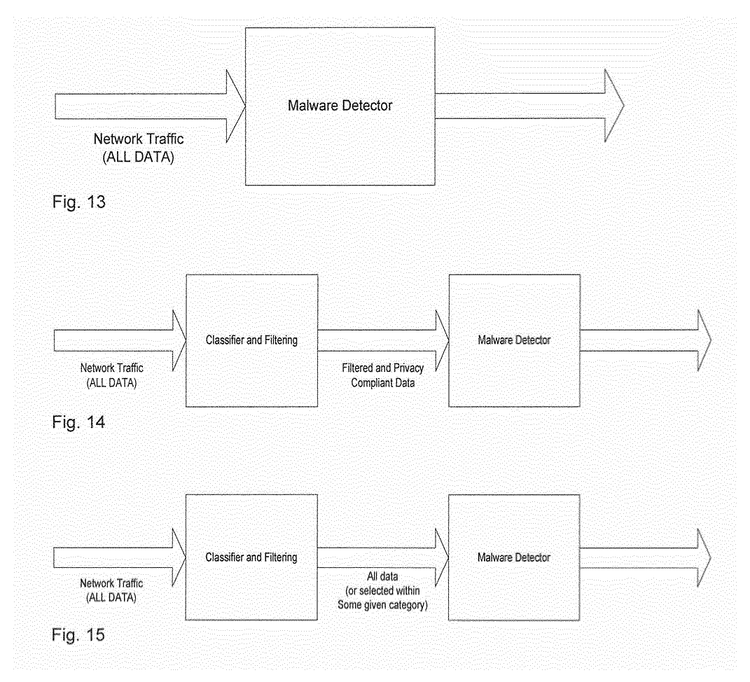

FIG. 13 illustrates the operation of a classical malware detector, where all traffic is presented to a data scanning component. This has several performance and privacy issues. If the classification and filtering component is placed in-line, the traffic passed to the data scanning may be limited in fidelity. FIG. 14 illustrates a data scanning process that merely suppresses sensitive data fields, wherein the classifier merely suppresses potentially sensitive data, and the data scanning is not effective enough.

If the malware detector detects potential malware then the classification and filtering may be changed to a less restrictive operation mode, such that more data is made available, with greater privacy risk but greater fidelity. FIG. 15 illustrates a data scanning process with smart data processing according to an exemplary embodiment. If with this greater fidelity of data no malware is found, the data scanning entity may return to a normal state.

Another possible mode of operation is where the data scanning entity operates normally but unfiltered traffic is presented to an access-restricted node, e.g. encrypted storage, such that it is not possible to read or tamper with the highly sensitive data. Thus at least part of the privacy sensitive data may be directed in an encrypted storage to prevent data scanning to be performed on said privacy sensitive data, and, if required, the privacy sensitive data may be retrieved from the encrypted storage in order to allow data scanning to be performed on said privacy sensitive data.

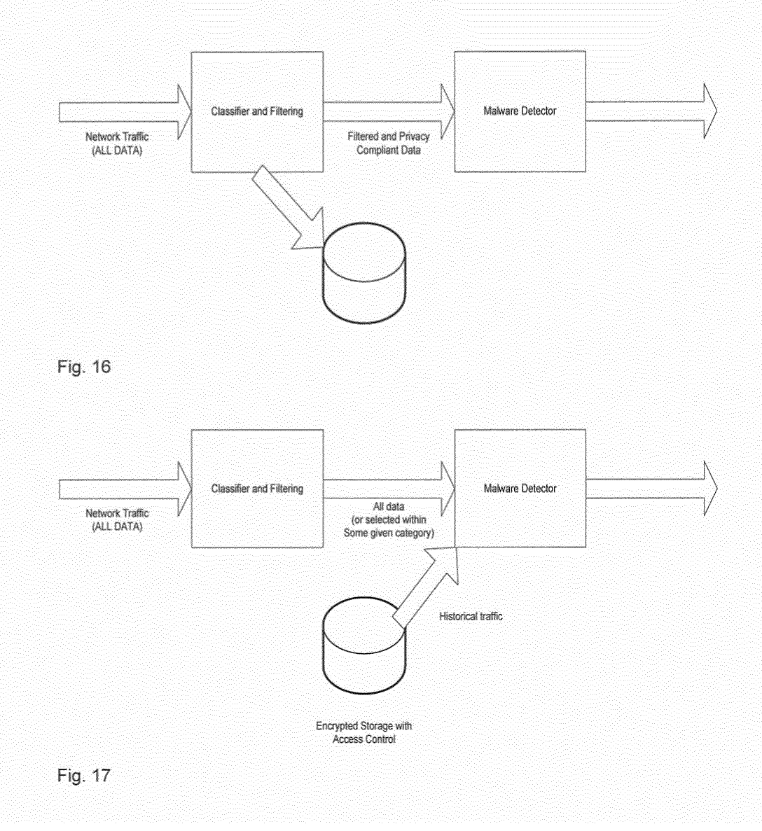

FIG. 16 illustrates separate storage usage for incident recovery and legal investigation. This allows “historic” replays of data if the data scanning entity moves to an alert mode, thus improving the overall fidelity of data and allowing the data scanning to work over previously unavailable, historical data.

FIG. 17 illustrates encrypted storage usage with access control. It may be assumed that the historical data is also time limited for the purposes of adherence to the necessary privacy laws. Thus the privacy sensitive data may be removed from the encrypted storage after a predetermined time limit has expired.

The classification and filtering may be carried out at any part of the network. For example, the classification and filtering may comprise centralised processing of the data, edge processing for initial classification and marking of the data with the malware detector being placed in-line at a different point, e.g. at a Gn interface, and/or edge processing as before and tagging of network packets such that these may be identified by utilizing SDN (software-defined networking) flow-table pattern matching.

An embodiment provides two ontologies for the classification of data: information type and usage. Also other ontologies may be applied either in the sensitivity and identifiability calculations or in the risk calculation, or as an additional partial field order calculations over the system as a whole. Such ontologies include but are not limited to: provenance, purpose (primary data vs. secondary data), identity characteristics, jurisdiction (including source, routing properties, etc.), controller classification, processor classification, data subject classification, personally identifiable information (PII) classification (including sensitive PII classification, e.g. HIIPA health classifications), personal data classification (including sensitive personal data classification), traffic data, and/or management data.

Further ontologies may be included into the calculations by constructing a final metric by combination of the ontologies, for example, when calculating the sensitivity, the metric may be a function f(usage×information type), however, this may be generalised into a function f(ontology1×ontology2×ontology3× . . . ×ontologyN). Further ontologies may also be included into the calculations by constructing the cross-product of two or more of the calculations. For example, when calculating the cross product of the partial orders of the usage against sensitivity Ls×Lu, this may be generalised into L1×L2× . . . ×Ln.

An embodiment enables a technical implementation and handling of network communication traffic such that the network provider is able to protect user data in the core network (e.g. P-CSCF, S-SCSF, HSS) against malicious activities in the communication networks without mass surveillance and loss of the right of privacy of the users.

An embodiment enables a mechanism that makes privacy compliance and the consumer perception of the data collection more in line with what is expected, meaning justified collection, processing and usage of data, and legal compliance to local privacy legislations.

An embodiment enables data scanning by processing the data sets with respect to their content, usage and data scanning categorisation.

Let us now describe an embodiment for optimizing data scanning with reference to FIG. 18. Referring to FIG. 18, the second network node NE2 is configured to receive 181, from the first network node, an output message indicating selected data fields for which data scanning is to be performed in the second network node. Based on the receiving, the second network node is configured to perform 182 data scanning on the selected data fields indicated by the output message.

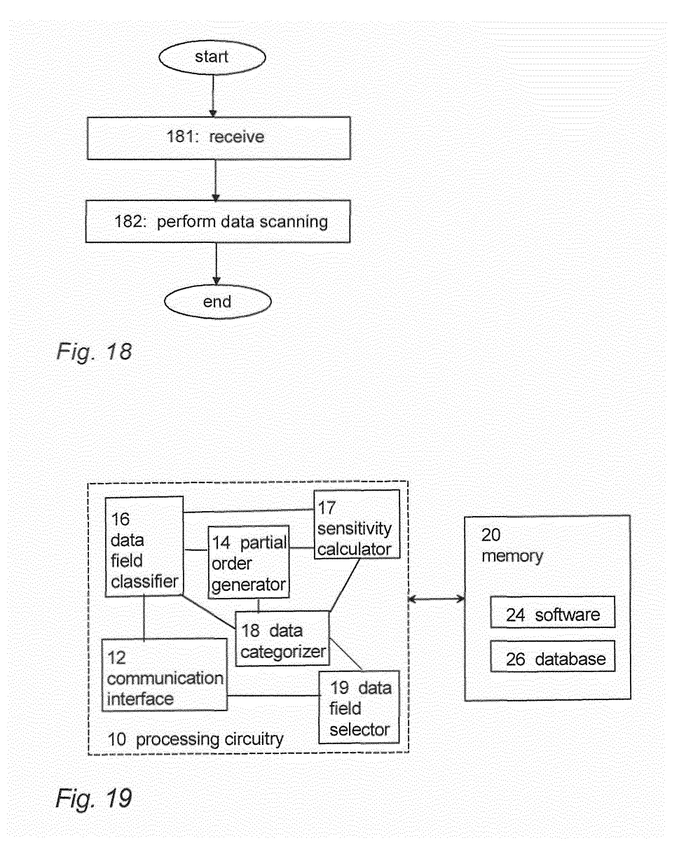

An embodiment provides an apparatus comprising at least one processor and at least one memory including a computer program code, wherein the at least one memory and the computer program code are configured, with the at least one processor, to cause the apparatus to carry out the procedures of the above-described network element or the network node. The at least one processor, the at least one memory, and the computer program code may thus be considered as an embodiment of means for executing the above-described procedures of the network element or the network node. FIG. 19 illustrates a block diagram of a structure of such an apparatus. The apparatus may be comprised in the network element or in the network node, e.g. the apparatus may form a chipset or a circuitry in the network element or in the network node. In some embodiments, the apparatus is the network element or the network node. The apparatus comprises a processing circuitry 10 comprising the at least one processor. The processing circuitry 10 may comprise a communication interface 12 configured to acquire data transmitted between network nodes of a communication system. The processing circuitry 10 may further comprise a data field classifier 16 configured to classify data fields of a data set based on selected characteristics of the data fields. The data field classifier 16 may be configured to classify the data fields, as described above, and output information on the classified data fields to a sensitivity calculator 17 configured to calculate the sensitivity of the data fields. The processing circuitry 10 may further comprise a partial order generator 14 configured to form a first partial order of the data fields based on their sensitivity and a second partial order of the data fields based on their usage. The processing circuitry 10 may further comprise a data categorizer 18 configured to sort the data fields into data scanning categories based on the first partial order and the second partial order, and a data field selector 19 configured to select a minimum set of data fields from each of the data scanning categories. Responsive to the selecting, the communication interface 12 is configured to provide an output indicating selected data fields for which data scanning is to be performed.

The processing circuitry 10 may comprise the circuitries 12 to 19 as subcircuitries, or they may be considered as computer program modules executed by the same physical processing circuitry. The memory 20 may store one or more computer program products 24 comprising program instructions that specify the operation of the circuitries 12 to 19. The memory 20 may further store a database 26 comprising definitions for traffic flow monitoring, for example. The apparatus may further comprise a radio interface (not shown in FIG. 19) providing the apparatus with radio communication capability with the terminal devices. The radio interface may comprise a radio communication circuitry enabling wireless communications and comprise a radio frequency signal processing circuitry and a baseband signal processing circuitry. The baseband signal processing circuitry may be configured to carry out the functions of a transmitter and/or a receiver. In some embodiments, the radio interface may be connected to a remote radio head comprising at least an antenna and, in some embodiments, radio frequency signal processing in a remote location with respect to the base station. In such embodiments, the radio interface may carry out only some of radio frequency signal processing or no radio frequency signal processing at all. The connection between the radio interface and the remote radio head may be an analogue connection or a digital connection. In some embodiments, the radio interface may comprise a fixed communication circuitry enabling wired communications.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described above in connection with FIGS. 1 to 19 may also be carried out in the form of one or more computer process defined by one or more computer programs. The computer program shall be considered to encompass also a module of a computer programs, e.g. the above-described processes may be carried out as a program module of a larger algorithm or a computer process. The computer program(s) may be in source code form, object code form, or in some intermediate form, and it may be stored in a carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to cellular or mobile communication systems defined above but also to other suitable communication systems. The protocols used, the specifications of cellular communication systems, their network elements, and terminal devices develop rapidly. Such development may require extra changes to the described embodiments. Therefore, all words and expressions should be interpreted broadly and they are intended to illustrate, not to restrict, the embodiment.

It will be obvious to a person skilled in the art that, as the technology advances, the inventive concept can be implemented in various ways. The invention and its embodiments are not limited to the examples described above but may vary within the scope of the claims.

1. A method, comprising:
acquiring, in a first network node, data transmitted between network nodes of a communication system;
processing, in the first network node, the acquired data in order to optimize data scanning in the communication system; and
providing, in the first network node, an output, wherein the output indicates selected data fields for which data scanning is to be performed;
wherein the step of processing the acquired data comprises
classifying, in the first network node, data fields of a data set based on selected data scanning characteristics of the data fields;
based on the classifying, calculating, in the first network node, the sensitivity of the data fields;
forming, in the first network node, a first partial order of the data fields based on their sensitivity;
forming, in the first network node, a second partial order of the data fields based on their usage;
based on the first partial order and the second partial order, sorting, in the first network node, the data fields into data scanning categories;
selecting, in the first network node, a minimum set of data fields from each of the data scanning categories.

2. The method according to claim 1, wherein the step of processing the acquired data comprises
classifying, in the first network node, data fields of a data set according to their usage;
classifying, in the first network node, the data fields of the data set according to their information type;
classifying, in the first network node, the data fields of the data set according to identifiability of the data set.

3. The method according to claim 1, wherein the step of processing the acquired data comprises
selecting, in the first network node, a minimum set of data fields from each of the data scanning categories, the selected minimum set of data fields satisfying a lowest risk level; and
defining that data scanning is to be performed on the selected minimum set of data fields.

4. The method according to claim 1, wherein the step of providing the output comprises transmitting an output message to a second network node, the output message indicating the selected data fields for which the data scanning is to be performed in the second network node.

5. The method according to claim 1, wherein the method comprises performing, in the first network node, data scanning the selected data fields.

6. The method according to claim 1, wherein the method comprises at least partly preventing data scanning to be performed on privacy sensitive data.

7. The method according to claim 1, wherein the method comprises at least partly preventing data scanning to be performed on private data.

8. The method according to claim 1, wherein the method comprises
if required, selecting, in the first network node, the minimum set of data fields such that the selected minimum set of data fields satisfies a risk level that is higher than a lowest risk level.

9. The method according to claim 1, wherein the method comprises
selecting, in the first network node, the minimum set of data fields by applying a noise reduction or noise addition mechanism, such as differential privacy, l-diversity, t-closeness, k-anonymity.

10. The method according to claim 1, wherein the method comprises
temporarily setting the operation mode of a network node such that the network node is to perform data scanning on selected data fields only.

11. The method according to claim 1, wherein the method comprises
directing at least part of the privacy sensitive data in an encrypted storage to prevent data scanning to be performed on said privacy sensitive data; and
if required, retrieving the privacy sensitive data from the encrypted storage in order to allow data scanning to be performed on said privacy sensitive data.

12. The method according to claim 11, wherein the method comprises removing the privacy sensitive data from the encrypted storage after a predetermined time limit has expired.

13. An apparatus, comprising;
at least one processor; and
at least one memory including a computer program code, wherein the at least one memory and the computer program code are configured, with the at least one processor, to cause the apparatus to
acquire data transmitted between network nodes of a communication system;
process the acquired data in order to optimize data scanning in the communication system; and
provide an output, wherein the output indicates selected data fields for which data scanning is to be performed;
wherein the at least one memory and the computer program code are configured, with the at least one processor, to cause the apparatus to perform the step of processing the acquired data by
classifying data fields of a data set based on selected data scanning characteristics of the data fields;
based on the classifying, calculating the sensitivity of the data fields;
forming a first partial order of the data fields based on their sensitivity;
forming a second partial order of the data fields based on their usage;
based on the first partial order and the second partial order, sorting the data fields into data scanning categories; and
selecting a minimum set of data fields from each of the data scanning categories.

14. The apparatus according to claim 13, wherein the at least one memory and the computer program code are configured, with the at least one processor, to cause the apparatus to perform the step of processing the acquired data by
classifying data fields of a data set according to their usage;
classifying the data fields of the data set according to their information type;
classifying the data fields of the data set according to identifiability of the data set.

15. The apparatus according to claim 13, wherein the at least one memory and the computer program code are configured, with the at least one processor, to cause the apparatus to perform the step of processing the acquired data by
selecting a minimum set of data fields from each of the data scanning categories, the selected minimum set of data fields satisfying a lowest risk level; and
defining that data scanning is to be performed on the selected minimum set of data fields.

16. The apparatus according to claim 13, wherein the at least one memory and the computer program code are configured, with the at least one processor, to cause the apparatus to perform the step of providing the output by
transmitting an output message to a second network node, the output message indicating the selected data fields for which the data scanning is to be performed in the second network node.

17. The apparatus according to claim 13, wherein the at least one memory and the computer program code are configured, with the at least one processor, to cause the apparatus to perform data scanning on the selected data fields.

18. The apparatus according to claim 13, wherein the at least one memory and the computer program code are configured, with the at least one processor, to cause the apparatus to at least partly prevent data scanning to be performed on privacy sensitive data.

19.-25. (canceled)

26. An apparatus, comprising;
at least one communication interface configured to acquire data transmitted between network nodes of a communication system;
a data field classifier configured to classify data fields of a data set based on selected characteristics of the data fields;
a sensitivity calculator configured to calculate the sensitivity of the data fields;
a partial order generator configured to form a first partial order of the data fields based on their sensitivity and a second partial order of the data fields based on their usage;
a data categorizer configured to sort, based on the first partial order and the second partial order, the data fields into data scanning categories;
a data field selector configured to select a minimum set of data fields from each of the data scanning categories;
wherein the at least one communication interface is configured to provide an output indicating selected data fields for which data scanning is to be performed.

27. (canceled)

28. A computer program product embodied on a non-transitory computer readable medium and comprising program instructions which, when loaded into a computer, execute a computer process comprising causing a network node to perform the method of claim 1.
